(19) United States
(12) Patent Application Publication
(10) Pub. No.: US 2021/0344020 A1
(43) Pub. Date: Nov. 4, 2021

(54) Cap for a Fuel Cell/Candle

(71) Applicant: Hollowick Inc., Manlius, NY (US)

(72) Inventor: Thomas G. Haberer, Central Square, NY (US)

(73) Assignee: Hollowick Inc., Manlius, NY (US)

(21) Appl. No.: 16/864,571

(22) Filed: May 1, 2020

(51) Int. Cl. H01M 8/00; H01M 8/04223; H01M 8/0271; H01M 8/243

(52) U.S. Cl. CPC H01M 8/004; H01M 8/04223; F23D 14/28; H01M 8/243; H01M 8/0271

(57) ABSTRACT

The present invention provides a fuel cell cap that includes a flanged edge region in which a gasket is positioned, and which is adapted to be sealingly fit over the edge of fuel cell and successive heat energy transmitting sections that concentrate the heat energy for ultimate emission. A dome-shaped first region is integral with and positioned radially inward from the flanged edge region followed by a first stack region of cylindrical cross-sectional shape that is integral with and extending upwardly from the dome-shaped first region. Next, a second stack region of cylindrical cross-section shape extends upwardly from the first stack region and is of a second diameter smaller than the first diameter. Finally, an inwardly tapering region extends upwardly from the second stack region and emits the heat energy from the cap.

### BACKGROUND OF THE INVENTION

The present invention relates generally to caps placed over a fuel cell, such as a liquid fuel style candle. More specifically, the present invention generally relates to fuel cell caps used with fuel cells in the providing of ambiance in a restaurant or hospitality setting.

Liquid fuel cells used to heat or maintain the heat in food or to provide ambiance in a restaurant or other hospitality venue are typically capped to retain the wick and meter the length the candle will burn by controlling the level/quantity of oxygen and fuel flow through the cell. The fuel cells conventionally include a bottle/container in which liquid fuel is contained, a wick holder that retains a wick that extends vertically from the bottom of the container and out the top of the container, a cap to which the wick holder is integrated or attached and which is crimped in covering relation to the container to support/retain the wick holder and wick as it extends out of the container, and a plug that seals the opening of the cap through which the wick extends. The liquid fuel is conventionally mineral oil, paraffin or a mixture of paraffin and mineral oil, while the wick is composed of a material capable for delivering the fuel to its exposed tip where it will burn and provide heat and light.

The caps used in such applications are traditionally dome shaped with a single, cylindrical cross-section stack through which the wick opening is formed. While these traditional caps function well for the purpose for which they were designed, the capillary action of the wicks generally do not permit a sufficiently high enough flow rate of the liquid fuel to burn for extended periods. In addition, the design encourages carbon to build up on the wick, decreasing the light output below a desired threshold level. Nevertheless, because the design functions well for the duration for which it was initially intended, little attention has been paid to the design to improve its performance characteristics.

With reference to FIGS. 1 and 2, a prior art, traditional fuel cell cap 100 is shown. The fuel cell cap 100 includes the flanged region 102 in which a gasket is positioned for sealing over the peripheral edge of a fuel cell/candle. The dome shaped body 104 is integral with and positioned radially inwardly from the flanged region. The dome shape is useful for funneling/concentrating the heat energy generated by the fuel cell. A stack region 106 extends upwardly from the top of the dome shaped body 104 and is of a constant cross-sectional diameter and includes an open top through which the heat energy is emitted.

There is a desire, however, to obtain higher heat transfer from the flame and to also increase the length of time the candle will burn and provide heat to improve the lighting, heating and operating efficiency of the fuel cell.

It is therefore an object to provide a fuel cell cap and wick that improves upon the lighting, heating and operating efficiency of a fuel cell.

It is another object to provide a fuel cell cap and wick having a material composition that improves the capillary action of the liquid fuel.

It is a further object to provide a fuel cell and wick that reduces the level of carbon build up on the wick during the burn.

Other objects will in part appear hereinafter and in part be obvious.

### SUMMARY OF THE INVENTION

The present invention provides a cap for a fuel cell and a fuel cell system.

In one aspect of the invention, a fuel cell cap is provided, comprising a flanged edge region in which a gasket is positioned and which is adapted to be sealingly fit over the edge of fuel cell, the flanged edge region having a bottom edge; a dome-shaped first region that is integral with and positioned radially inward from the flanged edge region, the dome shaped first region having a bottom edge that extends in a common plane with the flanged edge region; a first stack region of cylindrical cross-sectional shape integral with and extending upwardly from the dome-shaped first region, the first stack region having a first diameter; a second stack region of cylindrical cross-section shape integral with and extending upwardly from the first stack region, the second stack region having a second diameter smaller than the first diameter; and a tapering region integral with and extending upwardly from the second stack region, the tapering region having a lower edge that is of the second diameter and an upper edge that is of a third diameter smaller than the second diameter.

In an embodiment, the tapering region further comprises a plurality of laterally spaced apart openings formed therethrough between its lower edge and its upper edge.

In an embodiment, successive ones of the plurality of laterally spaced apart openings are spaced equally apart.

In an embodiment, the fuel cell further comprises a third stack region that extends upwardly from the tapering region and is of the third diameter.

In another aspect, the invention provides a cap for a fuel cell having a rim of predetermined peripheral shape, the cap comprising a flanged edge region adapted to be sealingly fit over the edge of fuel cell, the flanged edge region having a bottom edge; a dome-shaped first region that is integral with and positioned inward from the flanged edge region, the dome shaped first region having a bottom edge that extends in a common plane with the flanged edge region; a first stack region of predetermined cross-sectional shape integral with and extending upwardly from the dome-shaped first region, the first stack region having a first cross-sectional area; a second stack region of predetermined cross-section shape integral with and extending upwardly from the first stack region, the second stack region having a second cross-sectional area smaller than the first cross-sectional area; and a tapering region integral with and extending upwardly from the second stack region, the tapering region having a lower edge that is of the second cross-sectional area and an upper edge that is of a third area smaller than the second cross-sectional area.

In an embodiment, the tapering region further comprises a plurality of laterally spaced apart openings formed therethrough between its lower edge and its upper edge.

In an embodiment, successive ones of the plurality of laterally spaced apart openings are spaced equally apart.

In an embodiment, the fuel cell further comprises a third stack region that extends upwardly from the tapering region and is of the third cross-sectional area.

In an aspect, a fuel cell cap is provided, comprising a flanged edge region adapted to be sealingly fit over the edge of the fuel cell, the flanged edge region having a bottom edge; and a first region that is integral with and positioned radially inward from the flanged edge region, the first region having a wick opening formed therethrough and a plurality of air vents formed therethrough.

In an embodiment, the wick opening is positioned centrally through the first region and the plurality of air vents are positioned radially outwardly from the wick opening.

In an embodiment, the first region is dome shaped.

In an embodiment, the first region is planar in shape.

In an embodiment, the fuel cell cap further comprises a wick support that extends through the wick opening.

### BRIEF DESCRIPTION OF THE DRAWINGS

The present invention will be more fully understood and appreciated by reading the following Detailed Description in conjunction with the accompanying drawings, in which:

FIG. 1 is a perspective view of a prior art fuel cap;

FIG. 2 is a cross-sectional view of a prior art fuel cap taken along section line 2-2 of FIG. 1;

FIG. 3 is a perspective view of a fuel cap, in accordance with an embodiment of the present invention;

FIG. 4 is a perspective view of a fuel cap and fuel cell with the fuel cell producing a flame, in accordance with an embodiment of the present invention;

FIG. 5 is a cross-section view of a fuel cap taken along section line 5-5 of FIG. 4, in accordance with an embodiment of the present invention;

FIG. 6 is a perspective view of a fuel cap and fuel cell, in accordance with an embodiment of the present invention;

FIG. 7 is a perspective view of a fuel cap, in accordance with an embodiment of the present invention.

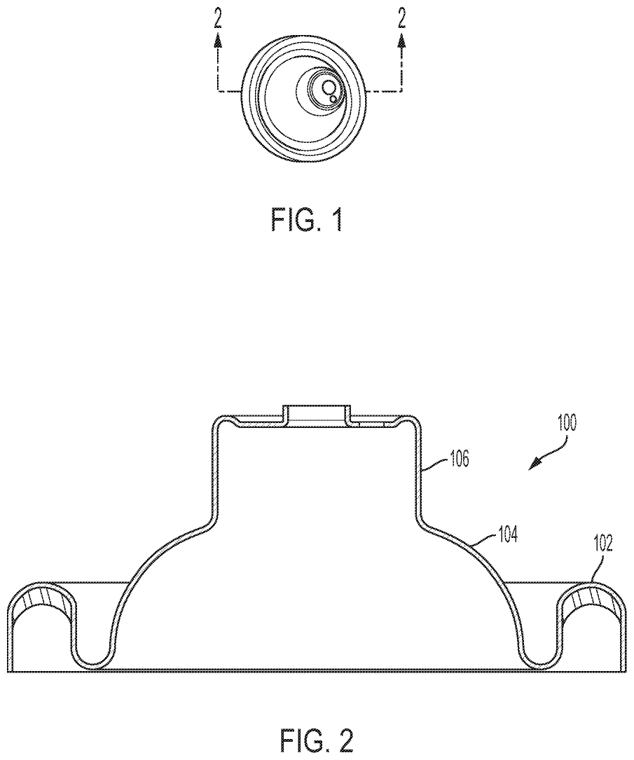

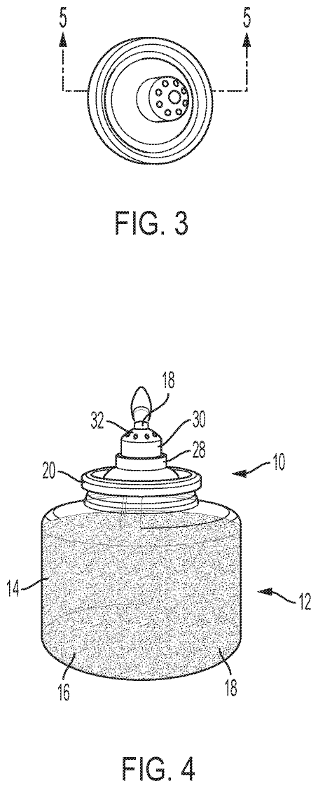

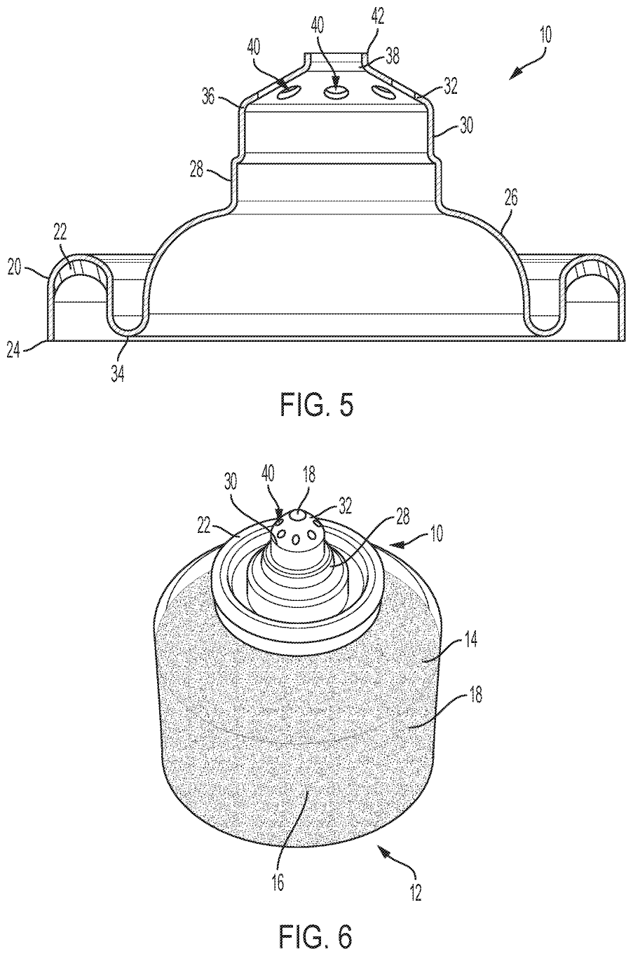

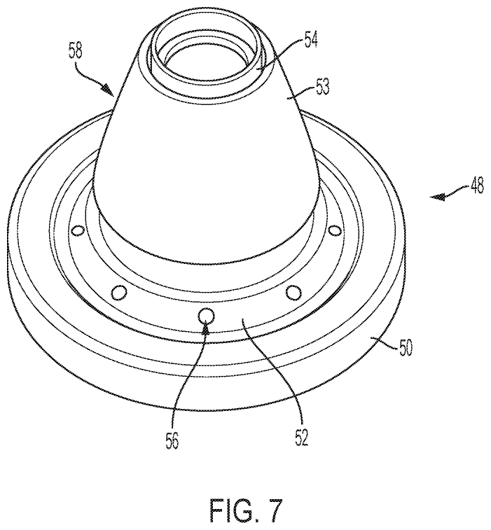

### DETAILED DESCRIPTION

A cap, designated generally by reference numeral 10, for a fuel cell assembly 12, and a bottle/container 14 is shown in the Figures.

Fuel cell 12 is conventional. It comprises a bottle/container 14 in which liquid fuel 16 is contained, a fuel absorbing wick 18, a wick holder 19 through which the wick extends and is supported such that it extends vertically from the bottom of the container and out the top of the container, and cap 10 to which wick holder 19 is either attached or integral with. Cap 10 is positioned in sealed, covering relation to container 14, most typically through crimping, and wick 18 extends outwardly through cap 10.

In an embodiment, cap 10 comprises a flanged edge region 20 in which a gasket 22 is positioned and which is adapted to be crimped/sealingly fit over the edge of container 14. The flanged edge region 20 includes a bottom edge 24, a dome-shaped first region 26 that is integral with and positioned radially inward from the flanged edge region 24, a first stack region 28 of cylindrical cross-sectional shape integral with and extending upwardly from the dome-shaped first region 26, a second stack region 30 of cylindrical cross-section shape integral with and extending upwardly from the first stack region 28, and a tapering region 32 integral with and extending upwardly from the second stack region 30.

The dome shaped first region 26 includes a bottom edge 34 that extends in a common plane with the flanged edge region 20. The first stack region 28 is of a first diameter and the second stack region 30 is of a second diameter smaller than the first diameter. The tapering region 32 includes a lower edge 36 that is of the second diameter and an upper edge 38 that is of a third diameter smaller than the second diameter.

The tapering region 32 further comprises a plurality of laterally spaced apart openings/vent holes 40 formed therethrough between its lower edge 36 and its upper edge 38. In one embodiment, the laterally spaced apart openings 40 are spaced equidistant apart. Preferably, to provide the most beneficial air flow and venting, the vent holes 40 are about 0.060 inches in diameter and eight of them are formed through cap 10. In addition, tapered region 32 preferably extends at a 60 degrees, plus or minus 10 degrees.

In an embodiment, the cap 10 further comprises a third stack region 42 that extends upwardly from the tapering region 32 and is of the third diameter.

In another embodiment, cap 48 includes a flanged edge region 50 (essentially the same as region 20) adapted to be sealingly fit over the edge of the container of a fuel cell. The flanged edge region 50 includes a bottom edge and a gasket that seals the connection between the cap and the container. Cap 48 further includes a first region 52 that is integral with and positioned radially inward from the flanged edge region 50, the first region having a wick retaining element 53 and a wick holder 54 (collectively a wick support 58) extending therethrough and a plurality of air vents 56 formed therethrough. A wick support 58 can be integral with or attached to cap 48 and extend through opening 54, and a wick can extend from the bottom of a container through wick support 58 and out the top of cap 48.

In this embodiment, the first region 52 is planar in shape essentially extending co-planar with the top edge of flanged edge region 50. It could, however, take on other shapes such as domed, for example. The air vents/vent openings 56 are for all practical purposes the same as vent holes 40.

What is claimed is:

1. A fuel cell cap, comprising:
a. a flanged edge region in which a gasket is positioned, and which is adapted to be sealingly fit over the edge of fuel cell, the flanged edge region having a bottom edge;
b. a dome-shaped first region that is integral with and positioned radially inward from the flanged edge region, the dome shaped first region having a bottom edge that extends in a common plane with the flanged edge region;
c. a first stack region of cylindrical cross-sectional shape integral with and extending upwardly from the dome-shaped first region, the first stack region having a first diameter;
d. a second stack region of cylindrical cross-section shape integral with and extending upwardly from the first stack region, the second stack region having a second diameter smaller than the first diameter; and
e. a tapering region integral with and extending upwardly from the second stack region, the tapering region having a lower edge that is of the second diameter and an upper edge that is of a third diameter smaller than the second diameter.

2. The fuel cell cap according to claim 1, wherein the tapering region further comprises a plurality of laterally spaced apart openings formed therethrough between its lower edge and its upper edge.

3. The fuel cell cap according to claim 2, wherein successive ones of the plurality of laterally spaced apart openings are spaced equally apart.

4. The fuel cell cap according to claim 1, further comprising a third stack region that extends upwardly from the tapering region and is of the third diameter.

5. A cap for a fuel cell having a rim of predetermined peripheral shape, the cap comprising:
a. a flanged edge region adapted to be sealingly fit over the edge of fuel cell, the flanged edge region having a bottom edge;
b. a dome-shaped first region that is integral with and positioned inward from the flanged edge region, the dome shaped first region having a bottom edge that extends in a common plane with the flanged edge region;
c. a first stack region of predetermined cross-sectional shape extending upwardly from the dome-shaped first region, the first stack region having a first cross-sectional area;
d. a second stack region of predetermined cross-section extending upwardly from the first stack region, the second stack region having a second cross-sectional area smaller than the first cross-sectional area; and
e. a tapering region integral with and extending upwardly from the second stack region, the tapering region having a lower edge that is of the second cross-sectional area and an upper edge that is of a third area smaller than the second cross-sectional area.

6. The fuel cell cap according to claim 5, wherein the tapering region further comprises a plurality of laterally spaced apart openings formed therethrough between its lower edge and its upper edge.

7. The fuel cell cap according to claim 6, wherein successive ones of the plurality of laterally spaced apart openings are spaced equally apart.

8. The fuel cell cap according to claim 5, further comprising a third stack region that extends upwardly from the tapering region and is of the third cross-sectional area.

9. A fuel cell cap, comprising:
a. a flanged edge region adapted to be sealingly fit over the edge of the fuel cell, the flanged edge region having a bottom edge; and
b. a first region that is integral with and positioned radially inward from the flanged edge region, the first region having a wick opening formed therethrough and a plurality of air vents formed therethrough.

10. The fuel cell cap according to claim 9, wherein the wick opening is positioned centrally through the first region and the plurality of air vents are positioned radially outwardly from the wick opening.

11. The fuel cell cap according to claim 9, wherein the first region is dome shaped.

12. The fuel cell cap according to claim 9, wherein the first region is planar in shape.

13. The fuel cell cap according to claim 9, further comprising a wick support that extends through the wick opening.
